(19) United States
(12) Patent Application Publication
(10) Pub. No.: US 2012/0226554 A1
(43) Pub. Date: Sep. 6, 2012

(54) SYSTEM AND METHOD FOR PROVIDING DATA TO A PORTABLE COMMUNICATIONS DEVICE BASED ON REAL-TIME SUBSCRIBER BEHAVIOR

(76) Inventors: Jeffrey C Schmidt, Orlando, FL (US); Hrishikesh Gossain, Heathrow, FL (US)

(21) Appl. No.: 13/037,595

(22) Filed: Mar. 1, 2011

(51) Int. Cl. G06Q 30/00; G06F 17/30; G06Q 99/00

(52) U.S. Cl. 705/14.58; 705/1.1; 707/769; 707/E17.014

(57) ABSTRACT

Timely and relevant advertisements and/or data that are tailored to a subscriber based on real-time behavior information compared to historical behavior information derived from location histories of the subscriber and other subscribers, subscriber-defined preferences, etc. are served to the subscriber. Location history and real-time behavior information are compiled using location information derived from a variety of methods including GPS, associations between the subscriber's mobile communication device and network access points, and other location services.

### TECHNICAL FIELD OF THE INVENTION

The present invention relates generally to data serving and, more particularly, providing data that is tailored to a subscriber based on real-time behavior information compared to behavioral profiles derived from historical behavior and location information.

### BACKGROUND

Advertising using traditional media, such as television, radio, newspapers and magazines, is well known. Advertisers have used these types of media to reach a large audience with their advertisements. To reach a more responsive audience, advertisers have turned to targeted advertising.

Targeted advertising is a type of advertising whereby advertisements are rendered to consumers based on various traits of the consumers such as demographics and purchase history. Two principal forms of targeted advertising are behavioral targeting and contextual advertising.

Behavioral targeting allows website owners or advertisement networks to display content more relevant to the interests of an individual consumer viewing a webpage by using information collected on the consumer's web-browsing behavior, such as the pages the consumer has visited or the searches the consumer has made, to select which advertisements to display to that consumer. Most platforms identify consumers by assigning a unique identification cookie to each and every visitor to the site, thereby allowing the consumer to be tracked throughout their web journey.

Behavioral targeting systems utilize at least one of two decision-making methods to determine what advertisements to display. In one method, a self-learning onsite behavioral targeting system monitors visitor response to site content and learns what is most likely to generate a desired conversion event. A conversion event occurs when a consumer takes the marketer's intended action. If the consumer has visited a merchant's website, the conversion action might be making an online purchase, submitting a form to request additional information, and the like. In the second method, the behavioral targeting system uses a rules-based approach, allowing administrators to set the content and advertisements shown to those users with particular traits.

Contextual advertising is a form of targeted advertising for advertisements appearing on websites or other media, such as content displayed in mobile browsers. The advertisements themselves are selected and served to the display media by automated systems based on the content displayed to the consumer. A typical contextual advertising system scans the text of a website for keywords and outputs advertisements to the webpage based on what a consumer is viewing. The advertisements are typically displayed on the webpage or as pop-up ads. For example, if a consumer is viewing a website pertaining to literature and that website uses contextual advertising, the consumer may see advertisements for literature-related companies, such as used book-sellers, colleges offering literature degrees, and the like. Contextual advertising is also used by search engines to display advertisements on their search results pages based on the keywords in the consumer's query. Contextual advertising is also utilized in television commercials to target advertisements based on the demographics of the expected audience.

### SUMMARY

Because consumers are saturated with advertisements for goods and services, the timing and context of advertising is critical. The present invention utilizes the technology available in mobile communication devices (e.g. smart phones) including location services (e.g. GPS and WiFi AP proximity), accelerometers, wireless connectivity, and mapping tools to derive historical behavior information regarding a subscriber to effectuate highly targeted messaging. The system may also involve an advertisement server that is capable of storing—in a central database—and processing historical behavior information about subscribers, correlating (predicting) relationships between subscribers and commercial entities and delivering timely offers for goods or services. In other embodiments, a data server may be used to deliver data to a subscriber in a timely manner. For instance, traffic information may be delivered to a user if a prediction is made that the user is leaving home for work or vice-versa.

Consumers are creatures of habit; they repeatedly travel to the same locales, using the same routes, at predictable times of the day. If a consumer has visited a specific merchant one or more times recently, there is high probability that the consumer will return, or can be persuaded to return via a timely advertisement, to that merchant. Alternatively, that consumer may be persuaded to switch to a competing, yet comparable, merchant via a timely advertisement. A specific example of a timely advertisement would be the delivery of an e-coupon for a lunch special at a nearby restaurant—directly to a consumer's smart phone as the user exits a workplace at noon.

The advertisement server accomplishes this timely advertising by correlating historical behavior with a subscriber's real-time behavior, to predict future behavior. By using a centralized database, smart phone capabilities, and a wireless communications medium, an advertisement server can catalog a subscriber's preferences, travel patterns, associations made with merchants, and buying patterns and infer historical behavior information. Historical behavior information may consist of places visited recently, places visited frequently, date of visit, and the duration of a visit. Real-time behavior (e.g., mode of locomotion, direction, speed, location, time, type of route, etc.) is acquired through the facilities in a smart phone and submitted to the advertisement server in real-time, via a wireless network. Predicted behavior is then correlated with a list of offers posted to the database by advertisers. The advertisement server uses the wireless network to deliver a relevant and timely advertisement to the subscriber's mobile communication device.

According to one aspect of the present disclosure, a method of serving a relevant and timely advertisement to a subscriber via a portable electronic device of the subscriber includes receiving real-time location information regarding the electronic device; accessing a behavioral profile of the subscriber; comparing the real-time location information with the behavioral profile to predict real-time behavior information; selecting data based on the predicted real-time behavior information; and transmitting the data to the electronic device of the subscriber for rendering.

According to one embodiment of this method, the location information includes information regarding associations between the mobile communication device and one or more network access points.

According to one embodiment of this method, the data is an advertisement.

According to one embodiment of this method, the predicted real-time behavior information predicts that the subscriber will travel past a point-of-sale location associated with the advertisement.

According to one embodiment of this method, the predicted real-time behavior information predicts that the subscriber will purchase a first product or service similar to a second product or service referenced in the advertisement.

According to one embodiment of this method the data is a discount coupon.

According to one aspect of the present disclosure, a method of creating a behavioral profile of a subscriber includes receiving real-time location information regarding the subscriber; storing accumulated location information as a location history for the subscriber; determining behavioral patterns exhibited by the subscriber based on location history; and creating a behavioral profile associated with the subscriber based on the behavioral patterns exhibited by the subscriber.

According to one embodiment, this method further includes receiving historical behavior information; wherein determining behavioral patterns exhibited by the subscriber is further based on the historical behavior information.

According to one embodiment of this method, the location information includes information regarding associations between the mobile communication device and one or more network access points.

According to one embodiment of this method, the behavioral patterns include arrival or departure from a location.

According to one embodiment of this method, the behavioral patterns include purchase of a good or service.

According to one aspect of the present disclosure, an advertisement server includes a processor and a database; the processor configured to perform the steps of: receiving real-time location information regarding an electronic device; accessing a behavioral profile of a subscriber associated with the electronic device; comparing the real-time location information with the behavioral profile to predict real-time behavior information; selecting data based on the predicted real-time behavior information; and transmitting the data to the electronic device of the subscriber for rendering.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

### BRIEF DESCRIPTION OF THE DRAWINGS

FIG. 1 is a diagram illustrating an exemplary environment within which the disclosed techniques may be implemented.

FIG. 2 is a diagram illustrating an exemplary mobile communication device.

FIG. 3 is a diagram functionally illustrating an exemplary advertisement server.

FIG. 4 is a flow diagram of an exemplary method of producing behavior profiles.

FIG. 5 is a flow diagram of an exemplary method of producing behavior profiles.

FIG. 6 is a flow diagram of an exemplary method of providing timely and relevant advertisements.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

In the present document, embodiments are described primarily in the context of a portable wireless radio communications device, such as a mobile telephone. For purposes of description, the device will be referred to as a mobile communication device. It will be appreciated, however, that the exemplary context of a mobile telephone is not the only operational environment in which aspects of the disclosed systems and methods may be used. The disclosed systems and methods may be applied to various types of portable electronic devices, so long as the device has wireless radio communications capability. Therefore, the techniques described in this document may be applied to any type of appropriate electronic device, examples of which include a mobile telephone, a media player, a gaming device, a computer, a personal digital assistant (PDA), an electronic book reader, etc.

The advertisements and/or data stored, selected, rendered, displayed, output, or otherwise used by or with various embodiments of the present invention may be any type of advertisement and/or data including, for example, political advertisements, commercial advertisements, coupons, government warnings, behavioral suggestions, mood-altering displays, traffic reports, weather reports, news, and so on. The following description is made in the exemplary context of advertisements and advertising, but may apply equally to other contexts, such as information delivery.

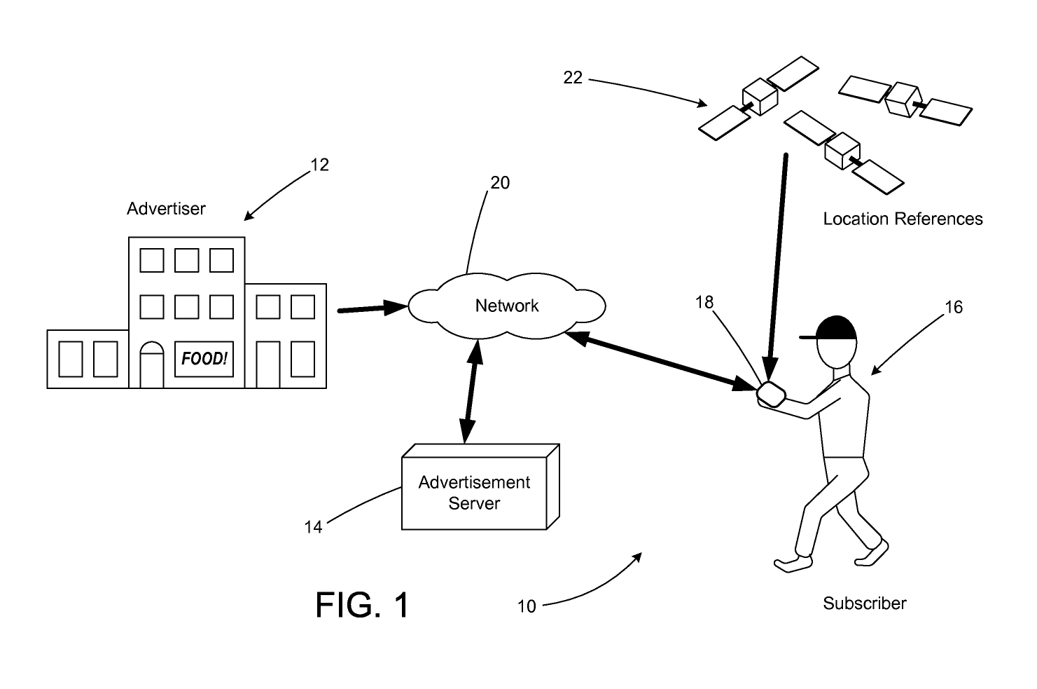

Referring initially to FIG. 1, shown is an exemplary environment 10 within which the invention may be implemented. The environment includes one or more advertisers 12, an advertisement server 14, a subscriber 16 with a mobile communication device 18, a network 20, and location references 22.

The advertisers 12 may be one or more parties that directly sell the goods or services being advertised (e.g., a retailer, a restaurant, etc.) or an agent authorized to act on the advertiser's 12 behalf. One of ordinary skill in the art will appreciate that the advertisement desired to be displayed by an advertiser 12 may exist in a variety of forms including embedded webpage advertisements, video advertisements, audio advertisements, audio/visual advertisements, e-coupons, e-mail messages, text messages, instant messages, or any other type of sensory message capable of being rendered by the mobile communication device 18.

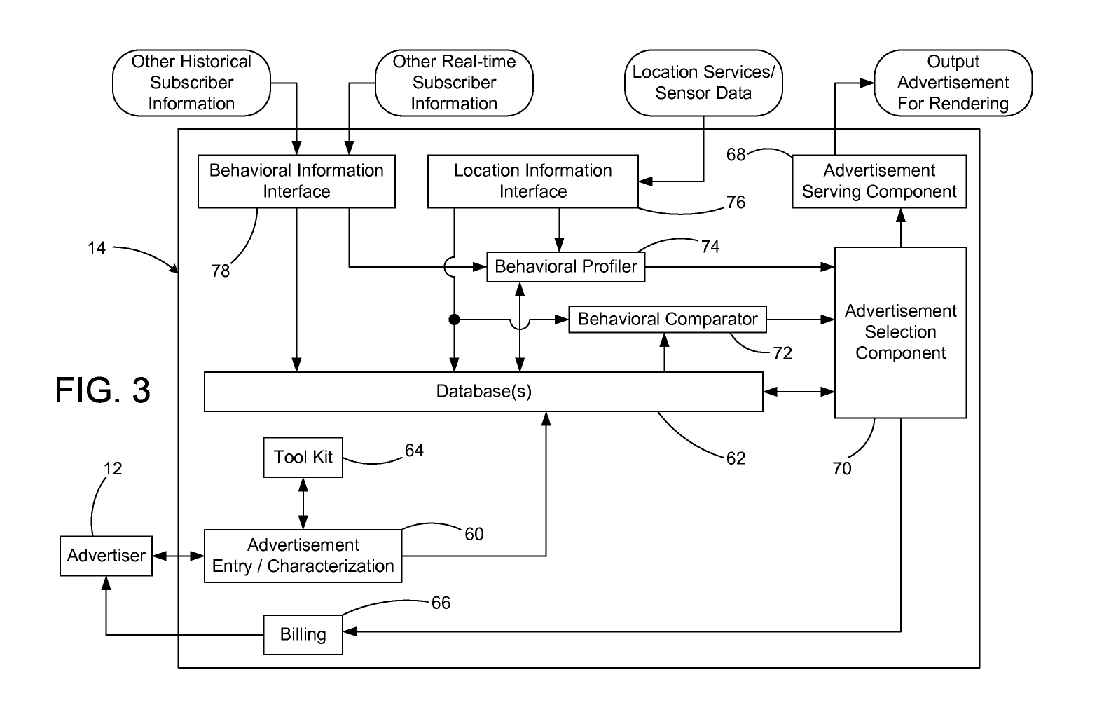

The advertisement server 14 may interface with the one or more advertisers 12 and networks 20. The advertisement server 14 may perform a variety of functions, as explained in more detail below in reference to FIG. 3.

The subscriber 16 may be, for example, an individual who has downloaded and installed an application or other software to run on the mobile communication device 18 that makes use of or embodies at least aspects of the present invention. The subscriber 16 is the individual to whom the advertisements served by the advertisement server 14 are directed.

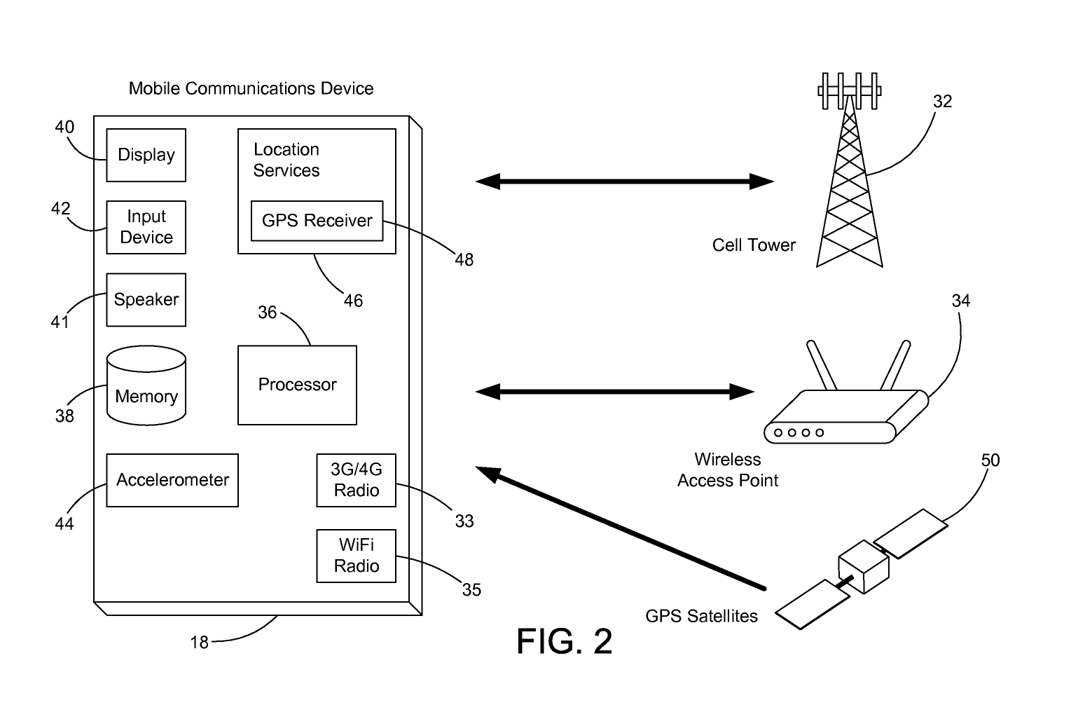

The mobile communication device 18 may interface with one or more networks 18 and/or location references 22 using various communication means. The mobile communication device 18 may perform a variety of functions, as explained in more detail below in reference to FIG. 2.

The network 20 may be, for example, one or more servers and other communication devices making up the World Wide Web and other data and communications networks accessible to advertisers 12, advertisement server 14, and mobile communication device 18. Alternatively, network 20 may be, for example, a WiFi network (e.g., a network operating in accordance with IEEE 802.11), a WiMAX network (e.g., a network operating in accordance with IEEE 802.16), a global system for mobile communications (GSM) network, an enhanced data rates for global system for mobile communications (GSM) evolution (EDGE) network, a wideband code division multiple access (WCDMA) network, integrated services digital broadcasting (ISDB) network, high speed packet access (HSPA) network, etc. The network 20 may be compatible with 3G and/or 4G protocols. The network 20 may be accessed, for example, by a network access point such as a cell tower 32 or a wireless access point 34. As described more fully below, various devices and entities may use the network 20 to create, consume, transfer and otherwise interact with information on and through the network 20.

Location references 22 may be in direct or indirect communication with the mobile communication device 18 and/or the advertisement server 14. Location references may be used by the mobile communication device 18 or the advertisement server 14 to determine a relative or absolute location of the mobile communication device 18. Location references 22 may be, for example, the Global Positioning System (GPS) satellite constellation, one or more cellular phone towers, wireless access points, or any other wireless receiver or transmitter capable of being used to determine location. Exemplary methods for determining the location of the mobile communication device 18 are explained in more detail below in reference to FIG. 2.

Referring now to FIG. 2, shown is a diagram illustrating a mobile communication device 18 with which at least portions of the invention may be implemented. The mobile communication device 18 may be used to access the network 20 through a network access point. Such access may be in the form of telephone calls through a cell tower 32 using a cellular radio 33 or accessing the Internet or other data services through a cell tower 32 using the cellular radio 33 or through a wireless access point 34 using a WiFi radio 35. The mobile communication device 18 may also communicate directly or indirectly with the advertisement server 14, the advertiser 12, and/or the location references 22 by periodically transmitting information to and/or receiving information from such entities.

Overall functionality of the mobile communication device 18 may be controlled by a processor 36. The processor 36 may execute code stored in a memory 38 in order to carry out the operations of the mobile communication device 18. For instance, the processor 36 may be used to render an advertisement on the display 40. The memory 38 may be, for example, one or more of a buffer, a flash memory, a hard drive, a removable media, a volatile memory, a non-volatile memory, a random access memory (RAM), or other suitable device. In a typical arrangement, the memory 38 may include a non-volatile memory for long term data storage and a volatile memory that functions as system memory for the processor 36. The memory 38 may exchange data with the processor 36 over a data bus (not shown). Accompanying control lines and an address bus between the memory 38 and the processor 36 also may be present.

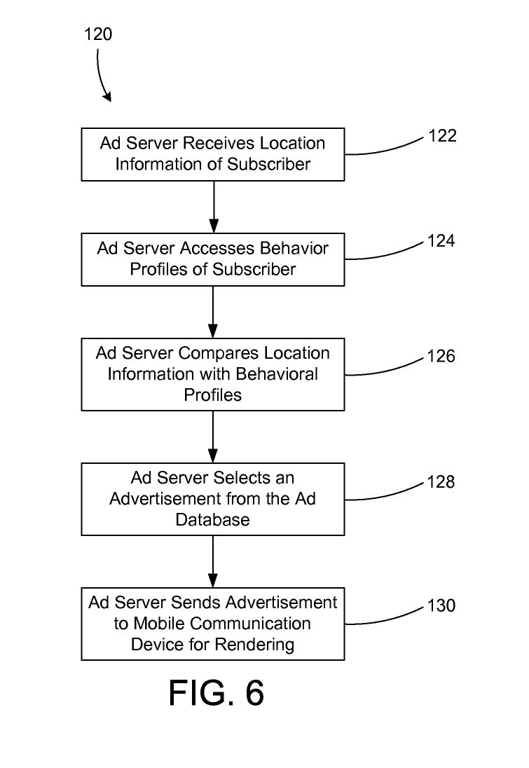

One or more displays 40 (e.g., an LCD screen, or the like) and one or more speakers 41 may act as principal output devices where advertisements are rendered on mobile communication device 18. The display 40 may also act as an input device 42 if it is a touch screen or similar device. The mobile communication device 18 may also include, in addition to or instead of a touch screen, one or more input devices 42 such as a keypad, joystick, navigation input, or the like. The mobile communication device 18 may also be equipped with one or more sensors, such as an accelerometer 44, which may collect real-time information that may be used by the advertisement server 14 to derive real-time behavior information as described in more detail below in reference to FIG. 6. The mobile communication device 18 may include other devices such as a microphone (not shown) to allow the user to carry out voice conversations or a camera (not shown) for taking digital pictures and/or movies. Image and/or video files corresponding to the pictures and/or movies may be stored in the memory 38.

An important aspect of the present invention requires some level of knowledge of the location of the subscriber 16. The mobile communication device 18 may provide a convenient means of locating and tracking the subscriber 16. For example, the mobile communication device 18 may include location services 46 to determine its location. The mobile communications device 18 may include, for example, a GPS receiver 48 adapted to receive signals from the constellation of GPS satellites 50. Location service 46 may use this information to derive the present location of the mobile communication device 18, which may be presumed to be the location of the subscriber 16 as well. Assisted-GPS (AGPS) also may be used to off-load some of the location-determination functions to an assistance server.

Location information may be deduced from any type of associations between the mobile communication device 18, and location references (such as cell towers 32 and/or wireless access points 34) that can be collected. The word “association” in this context refers to received signal strength, existence and length of connections, disconnection times, data transfer amounts, and the like as described herein.

Assorted electromagnetic or ultrasonic spectrum technologies may be used in various methodologies to provide the real-time locating in accordance with aspects of the present invention. The technologies utilized by these methodologies may include, for example:
Infrared (IR)
Active Radio Frequency Identification (Active RFID)
Active Radio Frequency Identification-Infrared Hybrid (Active RFID-IR)
Optical Locating
Low-frequency Signpost Identification
Semi-Active Radio Frequency Identification (semi-active RFID)
Radio Beacons
Ultrasound Identification (US-ID)
Ultrasonic Ranging (US-RTLS)
Ultrawide Band (UWB)
Wide-over-Narrow Band
Wireless Local Area Network (WLAN, WiFi)
Bluetooth
ZigBee®
Clustering technologies for increasing the accuracy of other systems
Bivalent Systems

The following methodologies may be used in accordance with aspects of the present invention for location sensing using, for example, any one or combination of the various technologies mentioned above:
Angle of Arrival (AoA): determines the direction of propagation of a wave incident on an antenna array. By measuring the Time Difference of Arrival (described below) at individual elements of the array the AoA may be determined with the mobile communication device 18 located at the intersection of two or more propagation paths.
Time of Arrival (ToA): determines the distance to a known reference by knowing the speed of a signal and the time the signal took to be received. This knowledge produces a hollow sphere of possible locations for each location reference.
Trilateration/Multilateration (or hyperbolic positioning): locates the mobile communication device 18 by accurately computing the time difference of arrival (TDOA)—or the difference in arrival time—of a signal emitted from the mobile communication device 18 to three or more receivers. Alternatively the mobile communication device 18 may be located by measuring the TDOA of a signal transmitted from three or more synchronized transmitters. Two common variations of this principle which may be used in accordance with the present invention are Uplink Time Difference of Arrival (U-TDOA) and Enhanced Observed Time Difference (E-OTD). Used by GPS, for example.
Reverse Triangulation: a radio gives a server the ID's of towers that it sees and corresponding RSSIs (signal strengths), and the server determines the location of the radio.
Received Channel Power Indicator (RCPI): is a measure of the received RF power in a selected channel of an 802.11 device.
Received Signal Strength Indication (RSSI): more general than RCPI, RSSI is a measurement of the power present in a received radio signal.
Near-field electromagnetic ranging (NFER): measures the phase difference between the electrical and magnetic components of an electromagnetic wave—which starts at 90 degrees out of phase near an antenna, and drops to zero far from the antenna—in order to deduce distance from a transmitter.
Location Signatures (or Fingerprinting): stored patterns (such as multipath propagations), which mobile phone signals are known to exhibit at different locations in each cell, are used to distinctly identify an area within a cell.

WiFi-based positioning systems, for example, take advantage of the rapid growth of wireless access points in urban areas. A public or private database of known access points may be utilized, and the position of the mobile communication device 18 may be inferred from the access points 34 accessible to the mobile communication device 18. If the database also contains surveyed maps of signal strength, fingerprinting may also be utilized to more precisely locate the mobile communication device 18.

In addition, hybrid positioning systems may be used to find the location of a mobile communication device 18 using several different positioning methods. GPS may be one major component of such systems, combined with, for example, cell tower 32 signals, wireless access point 34 signals, or Bluetooth sensors and other local positioning systems. These local positioning systems are specifically designed to overcome the limitations of GPS, which may be accurate in open areas, but may be of more limited use indoors or between tall buildings (the urban canyon effect). By comparison, cell tower 32 signals are not as hindered by buildings or bad weather, but may provide less precise positioning. WiFi signals may give very exact positioning, but only in urban areas with high WiFi density.

An example of a hybrid system which may be used in accordance with aspects of the present invention is Assisted GPS (A-GPS) which uses the network 20 to more quickly locate and better utilize the GPS satellites 50, especially in poor signal conditions. The network 20 may supply, for example, orbital data for the GPS satellites 50 to the mobile communication device 18, enabling the mobile communication device 18 to lock on to the satellites 50 more rapidly in some cases. The network 20 can provide the precise time. Accurate, surveyed coordinates for the cell towers 32 combined with their own received signals may provide better knowledge of local atmospheric conditions affecting the GPS signal, enabling more precise calculation of position. Further, the calculation of position may be made by the advertisement server 14 or other network 20 resource using information from the mobile communication device 18 utilizing a better satellite signal and plentiful computation power.

Any means known to one skilled in the art may be used to locate the subscriber 16, and the examples contained herein are exemplary only, and are not meant to be limiting.

The location and other functional aspects of the device 18 may be embodied in executable code (e.g., a program) that is stored on a non-transitory computer readable medium (e.g., the memory 38) that, when executed, carries out the described functionality.

Referring now to FIG. 3, shown is a diagram functionally illustrating an advertisement server 14 in accordance with aspects of the present invention. The advertisement server 14 may include, for example, a microprocessor, data storage component, memory module, and communications device (e.g. a modem) (all not shown). The advertisement server 14 may be, for instance, a general purpose computer or server. Functionally, the advertisement server 14 includes an advertisement entry and characterization component 60, one or more databases 62, a toolkit component 64, a billing component 66, an advertisement serving component 68, an advertisement selection component 70, a behavioral comparator 72, a behavioral profiler 74, a location information interface 76, and a behavioral information interface 78. The components of the advertising server 14 will be explained below. Furthermore, although FIG. 3 shows a particular arrangement of components constituting the advertisement server 14, one of ordinary skill in the art will recognize that not all components need be arranged as shown, not all components are required, and that other components may be added to, or replace, those shown.

The functional aspects of the advertisement server 14 may be embodied in executable code (e.g., a program) that is stored on a non-transitory computer readable medium (e.g., a memory) that, when executed, carries out the described functionality.

The advertisement entry and characterization component 60 is a component by which an advertiser 12 enters information required for an advertising campaign and manages the campaign. An advertisement campaign contains one or more advertisements that are related in some manner. For example, a retailer may have an advertisement campaign for clothes or tools, which could contain a series of advertisements related to that topic. Other things that may be provided by an advertiser 12 through the advertisement entry and management component 60 include the following: geographic targeting information (i.e., areas in which the ad should appear), behavioral targeting information (e.g., to be correlated with purchase behavior or set preferences), a value indication for the advertisement, start date, end date, etc. The data required for, or obtained by, the advertisement entry and characterization component 60 may reside in one of the databases 62. Whether or not the advertiser 12 provides geographic or behavioral targeting information about an advertisement, the advertisement entry and characterization component 60 may provide an automated analysis or characterization of the advertisement that supplements or replaces any targeting information provided by the advertiser 12. Such automated analysis may be performed using any method known to a person of ordinary skill in the art.

The database(s) 62 may contain a variety of data used by the advertisement server 14. In addition to the information mentioned above in reference to the advertisement entry and characterization component 60, the databases 62 may contain, for example, statistical information about what advertisements have been shown, how often they have been shown, who has viewed those advertisements, how often display of the advertisements has led to a conversion (e.g., a subsequent purchase of the advertised product or service), and so on. Although the databases 62 are shown in FIG. 3 as one unit, a person of ordinary skill in the art will recognize that multiple databases 62 may be employed for gathering and storing information used in the advertisement server 14 and that the databases 62 may be stored in one or more servers.

The toolkit component 64 may contain a variety of tools designed to help the advertiser 12 create, monitor, and manage its advertising campaigns (e.g., for goods, services, political office, and so on). For example, the toolkit component 64 may contain an interactive map which advertisers 12 can use to select geographic regions where point-of-sale locations are located, or in which areas advertisements should be served. As a further example, the toolkit component 64 may contain a tool for helping the advertiser 12 estimate the number of selections or renderings an advertisement will receive for a particular topic or location. Similarly, the toolkit component 64 may be used to help the advertiser 12 generate a list of topics or behavior profiles for a given advertisement, or to generate additional topics or behavior profiles based on ones already supplied by advertiser 12. Other possible tools may be provided as well. Depending on the nature of the tool, one or more databases 62 may be used to gather or to store the information.

The billing component 66 may perform billing-related functions. For example, the billing component 66 may generate invoices for a particular advertiser 12. In addition, the billing component 66 may be used by the advertiser 12 to monitor the amount being expended for its various advertisements. The data required for, or obtained by, the billing component 66 may reside in the database 62.

The advertisement serving component 68 may receive an advertisement selection from advertisement selection component 70 and format that advertisement into a manner suitable for presenting to the subscriber 16. This process may involve, for example, rendering the advertisements into hypertext markup language (HTML), into a proprietary data format, etc.

The advertisement selection component 70 may select one or more advertisements for rendering to the subscriber 16. Details of this selection process are provided more fully below, in relation to FIG. 6. The advertisement selection component 70 may receive information from, for example, the database 62, the behavioral comparator 72, and the behavioral profiler 74 in order to make these selections. The advertisement selection component 70 may communicate with the billing component 66 and/or the database 62 for noting the selection of a particular advertisement.

The behavioral comparator 72 may retrieve historical behavior information and or behavioral profiles from database 62 and receive real-time location information from the location information interface 76. The behavioral comparator 72 may compare real-time location information regarding the subscriber 16 to historical behavior information and/or behavioral profiles of this or another subscriber in order to determine the probability that subscriber 16 is engaging in a habitual behavior such that a relevant advertisement might be served. The threshold probability may be any threshold value (0%-100%) which is thought to be advantageous. Such a value may be, for example, selected dynamically and based on past conversion rates.

The behavioral profiler 74 may receive real-time location information (which may include, for example, position information, velocity information, and the like) from the location information interface 76, may retrieve recent location history from the database 62, and may receive real-time subscriber information from the behavioral information interface 78. The behavioral profiler 74 may use this information to build behavioral profiles by any method known in the art. For example, the behavioral profiler 74 may compile location histories into a path that the subscriber 16 has habitually taken. This path information may be used, for example, by the behavioral comparator 72 to determine if a current path appears to match historical paths used by the subscriber 16, thereby predicting likely future locations of subscriber 16. Further, location information may be used to deduce buying habits. For example, if the subscriber 16 spends time (e.g., a half hour, an hour, etc.) connected to a wireless access point 34 at a local restaurant during lunch time, it can be inferred that the subscriber 16 purchases food at that restaurant on a regular basis. Such purchasing behavior may be built into a behavioral profile by the behavioral profiler 74. As another example, if the subscriber 16 leaves a workplace around a certain time most days and travels in one or more directions, and subsequently returns, it might be inferred that the subscriber 16 often goes out for a meal at that time.

The location information interface 76 may receive location services 46 data and accelerometer 44 data. The location information interface 76 may use any method known in the art to derive real-time location information, which may include, for example, simply converting data formats, combining recent location data into current path data, and the like. The location information interface 76 may also store location information in the database 62 to update the subscriber's 16 location history. Location information may be obtained, for example, from an application running on the mobile communication device 18, or from external services that locate and/or track the location of mobile devices.

The behavioral information interface 78 may receive information from the mobile communication device 18 or from other sources including the network 20. More specifically, the behavioral information interface 78 may receive other historical information about the subscriber 16. This historical information may include, for example, user preferences about products and services (e.g., from a social networking website, an online retailer's product recommendations engine, gift registries, and the like), location histories derived from information stored by other applications, purchase histories, demographic information, and the like. The behavioral information interface 78 may also receive other real-time subscriber information. For example, user-made entries in a social networking website (e.g., a status update) may provide information about current plans or locations of the subscriber 16, and may be obtained through an application on the mobile communication device 18 or from the network 20. Any of this information may be stored in the database 62 and/or sent to the behavioral profiler 74.

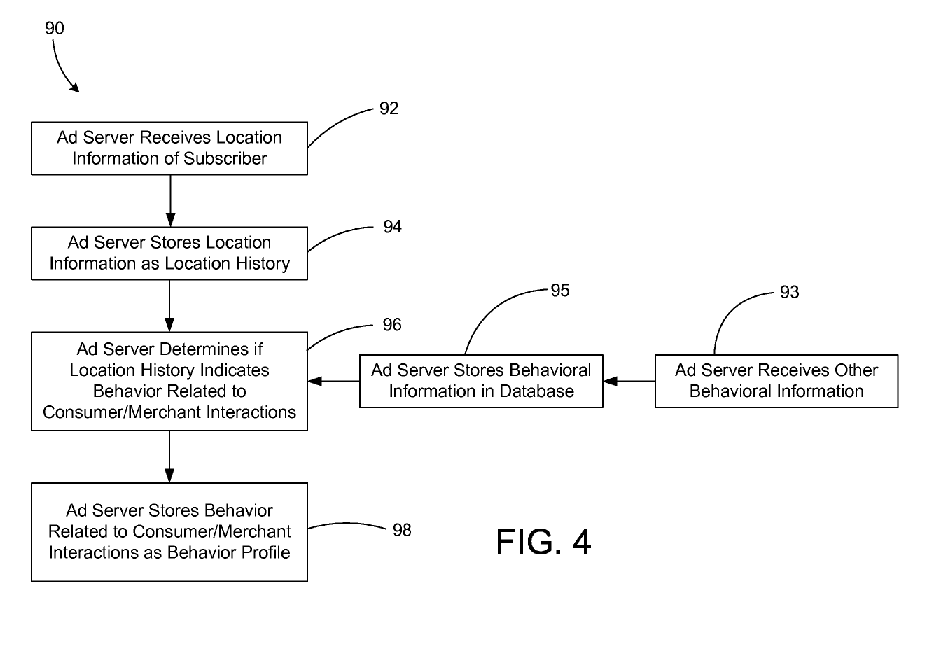

Referring now to FIG. 4, shown is a bock diagram of a method 90 of learning the behavior of the subscriber 16. For the sake of illustration, it may be understood that the method described herein takes place as part of the advertisement server 14.

At block 92, the advertisement server 14 receives location information regarding the subscriber 16. Location information may be received in real-time by the location information interface 76, or in the form of historical location data or location history received by the behavioral information interface 78. This location information may be, for example, made or broken network connections, received signal strengths, etc. The subscriber 16 may be identified, for example, by a MAC address, user login information, or the like.

At block 93, the behavioral information interface 78 receives other behavioral information related to the subscriber 16. This information may include, for example, purchase histories (e.g., from retailers, user provided, etc.), individual purchases made using the mobile communication device 18, the subscriber's 16 interests and demographic information provided by the subscriber 16 or obtained from social networking websites, wish lists, and the like.

At block 94, the advertisement server 14 stores the location information as location history in the database 62.

At block 95, the advertisement server 14 stores the behavioral information in the database 62.

At block 96, the behavioral profiler 74 determines if the location history, the real-time location information, and/or other behavioral information indicates any behavioral pattern. Further, the behavioral profiler 74 may determine if any behavioral patterns are associated with or related to consumer/merchant interactions (e.g., buying food as a restaurant at lunchtime) by comparing the location history with historical behavior information.

At block 98, the advertisement server 14 stores the results obtained in block 96 as behavioral profiles in the database 62.

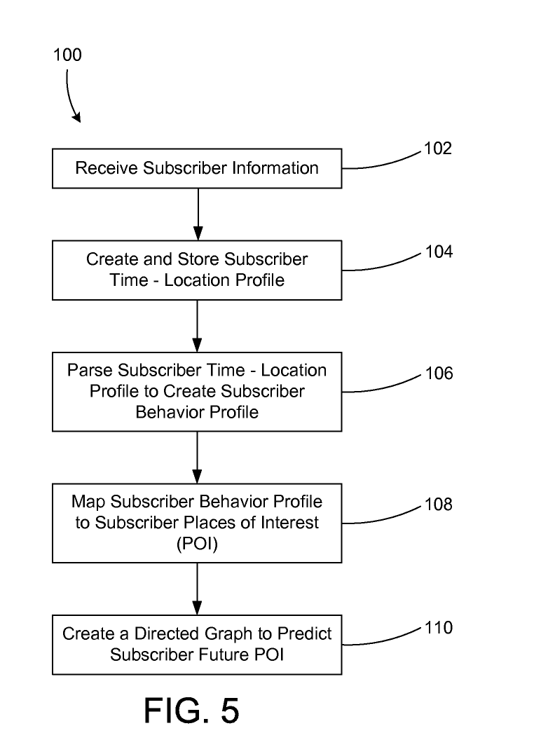

Referring now to FIG. 5, shown is a block diagram of a method 100 of learning the behavior of a subscriber 16. For the sake of illustration, it may be understood that the method described herein takes place as part of the advertisement server 14.

At block 102, the advertisement server 14 receives information regarding the subscriber 16. This information may include, for example, the identification of the subscriber 16, the date, time, location information, and the like. Information may be received in real-time by the location information interface 76, or in the form of historical location data or location history received by the behavioral information interface 78. The location information may be, for example, made or broken network connections, received signal strengths, etc. The subscriber 16 may be identified, for example, by a MAC address, user login information, or the like.

At block 104, the advertisement server 14 stores the information as a subscriber 16 time-location profile in the database 62.

At block 106, the behavioral profiler 74 parses the subscriber 16 time-location profile to create a subscriber 16 behavioral profile which is mapped, at block 108, to subscriber 16 places of interest (POIs). Information included in the behavioral profile may include, for example, the date, time, location (POI), the time spent at the POI, and the like. Database 62 may maintain a set of predefined POIs with location information for a subscriber (e.g., home, office, pharmacy, grocery, deli, etc.) The list of POIs for a subscriber 16 may be updated (e.g., a new POI added and an old POI removed after some threshold of inactivity has been reached) based on the behavior of the subscriber 16. Additionally or alternatively, database 62 may maintain a list of subscribers 16 for a given POI, with the list of subscribers 16 updated (e.g., a new subscriber 16 added and an old subscriber 16 removed after some threshold of inactivity has been reached) based on the behaviors of various subscribers 16.

An example of information stored by the database 62 relating to POIs can be seen in Table 1, below. The location of a POI may be stored as geographical coordinates (latitude and longitude), as a street address, or the like. A POI may be identified by a unique ID, by an associated access point, or the like. A POI may or may not have an associated message, advertisement, or coupon associated with it.

TABLE 1
POI data with coupon info

| | | | POI | | Coupon | |
|---|---|---|---|---|---|---|
| | | | image | POI AP | Avail- | Coupon |
| Lat. | Lon. | POI ID | ID | info | able | Info |
| 28.73796 | −81.3053 | 00698 | IMG0123 | MAC | Yes | [. . .] |
| | | | | ID(s), | | |
| | | | | SSID(s) | | |
| | | | | etc. | | |
| 28.74802 | −81.8772 | 00710 | IMG0123 | . . . | No | Null |
| 28.75596 | −81.3456 | 00334 | IMG0123 | . . . | Yes | [. . .] |
| 28.78262 | −81.347 | 00833 | IMG0123 | . . . | Yes | [. . .] |
| 28.80514 | −82.5766 | 00518 | IMG0123 | . . . | No | Null |
| 28.81154 | −81.3527 | 00641 | IMG0123 | . . . | No | Null |
| 28.81837 | −81.8877 | 00815 | IMG0123 | . . . | No | Null |
| 28.82183 | −81.7817 | 00349 | IMG0123 | . . . | No | Null |
| . . . | . . . | . . . | . . . | . . . | . . . | . . . |

At block 110, the advertisement server 14 creates a directed graph which may be used to predict future subscriber 16 behavior. The directed graph may take the form of, for example, a subscriber 16 transition matrix (an example of which is shown in Table 2) which includes the number of times a subscriber 16 transitions from one POI to another POI within a time of day window (e.g., a four hour block of time) over a period of time (e.g., a month).

TABLE 2
Transition Matrix

| | | | |
|---|---|---|---|
| To Home | To Office | To Deli | To Grocer |

Time: Morning (8-12 Noon)

| | | | | |
|---|---|---|---|---|
| From Home | 0 | 20 | 10 | 5 |
| From Office | 0 | 0 | 20 | 10 |
| From Deli | 1 | 20 | 0 | 0 |
| From Grocer | 3 | 0 | 2 | 0 |

Time: Afternoon (12-4 PM)

| | | | | |
|---|---|---|---|---|
| From Home | 0 | 0 | 0 | 2 |
| From Office | 0 | 0 | 5 | 5 |
| From Deli | 0 | 5 | 0 | 0 |
| From Grocer | 3 | 0 | 2 | 0 |

Table 3 shows another exemplary form of the directed graph formed at block 110. This transition probability matrix may include, for example, the estimated probability of a subscriber transitioning from one POI to another POI based on past behavior. For example, as shown in Table 3, the probabilities correspond to the historical data presented in Table 2.

TABLE 3
Transition Probability Matrix

| | | | |
|---|---|---|---|
| To Home | To Office | To Deli | To Grocer |

Time: Morning (8-12 Noon)

| | | | | |
|---|---|---|---|---|
| From Home | 0 | 20/35 | 10/35 | 5/35 |
| From Office | 0 | 0 | 20/30 | 10/30 |
| From Deli | 1/21 | 20/21 | 0 | 0 |
| From Grocer | 3/5 | 0 | 2/5 | 0 |

Time: Afternoon (12-4 PM)

| | | | | |
|---|---|---|---|---|
| From Home | 0 | 0 | 0 | 2/2 |
| From Office | 0 | 0 | 5/10 | 5/10 |
| From Deli | 0 | 5/5 | 0 | 0 |
| From Grocer | 3/5 | 0 | 2/5 | 0 |

In the context of coupon delivery, the advertisement server 14 may select a coupon associated with a POI when the chance of a subscriber 16 transitioning to the POI is greater than a threshold (e.g., 50%), thus indicating a likelihood of knowing real-time behavior information of the subscriber 16. The advertisement server may refer to a transition probability matrix stored in database 62 to determine whether the threshold has been met at any particular time of day. This determination of probable real-time behavior information for the subscriber 16 may be made on a regular basis or may, for example, be initiated by some event (e.g., a transition to or from a POI, an association with an access point, a time of day, or the like).

The advertisement server 14 may also track the use of a coupon by a subscriber. The use, or nonuse, of a coupon may be used to bias the coupon delivery probability for a given POI (i.e. the threshold corresponding to the transition probability matrix may be altered up or down for a given POI based on the subscriber's 16 use of a coupon).

Referring now to FIG. 6, shown is a bock diagram of a method 120 of serving a relevant advertisement to the subscriber 16. For the sake of illustration, it may be understood that the method described herein takes place as part of the advertisement server 14.

At block 122 the location information interface 76 receives location information of subscriber 16. This information may be received, for example, from a separate service or as part of an application run on the mobile communication device 18. Location information may be received in the form of GPS coordinates, relative distances or angles, associations between the mobile communication device 18 and network access points, or some other format known in the art. Location information may be dynamically updated as the subscriber 16 moves so as to track the location and speed of travel of the subscriber 16.

At block 124, the behavioral comparator 72 accesses behavioral profiles of the subscriber 16 stored in the database 62.

At block 126, behavioral comparator 72 compares the location information with the behavioral profiles to predict real-time behavior information.

At block 128, the advertisement selection component 70 selects one or more advertisements stored in the database 62 based on the predicted real-time behavior information. The one or more advertisements are selected by any means known in the art and are selected to be timely and relevant advertisements.

At block 130, the advertisement serving component 68 serves the advertisement to the mobile communication device 18 for rendering to the subscriber 16.

Although the illustrated methods illustrate a specific order of executing functional logic blocks, the order of execution of the blocks may be changed relative to the order shown and/or may be implemented in a state-driven or an object-oriented manner. Also, two or more blocks shown in succession may be executed concurrently or with partial concurrence. Certain blocks also may be omitted. Further, although certain blocks have been described as being executed or performed by specific functional components of the advertising server 14, these blocks need not be performed by these components or may be performed by one or more other components. It is understood that all such variations are within the scope of the present invention.

Any of the blocks of the methods 90, 100, 120 may be embodied as a set of executable instructions (e.g., referred to in the art as code, programs, or software) that are respectively resident in and executed by the advertisement server 14 and/or the mobile communication device 18. The methods 90, 100, 120 may each be one or more programs that are stored on respective non-transitory computer readable mediums, such as one or more memory devices (e.g., an electronic memory, a magnetic memory, or an optical memory). In the preceding description, ordered logical flows for the functionality of methods 90, 100, 120 are described. But it will be appreciated that the logical progression may be implemented in an object-oriented or a state-driven manner.

Although certain embodiments have been shown and described, it is understood that equivalents and modifications falling within the scope of the appended claims will occur to others who are skilled in the art upon the reading and understanding of this specification.

What is claimed is:

1. A method of serving relevant and timely data to a subscriber via a portable electronic device of the subscriber comprising:
receiving real-time location information regarding the electronic device;
accessing a behavioral profile of the subscriber;
comparing the real-time location information with the behavioral profile to predict real-time behavior information;
selecting data based on the predicted real-time behavior information; and
transmitting the data to the electronic device of the subscriber for rendering.

2. The method of claim 1, wherein the location information includes information regarding associations between the mobile communication device and one or more network access points.

3. The method of claim 1, wherein the data is an advertisement.

4. The method of claim 3, wherein the predicted real-time behavior information predicts that the subscriber will travel past a point-of-sale location associated with the advertisement.

5. The method of claim 3, wherein the predicted real-time behavior information predicts that the subscriber will purchase a first product or service similar to a second product or service referenced in the advertisement.

6. The method of claim 1, wherein the predicted real-time behavior information predicts that the subscriber will transition from a first place of interest to a second place of interest.

7. The method of claim 1, wherein the data is a discount coupon.

8. A method of creating a behavioral profile of a subscriber comprising:
receiving real-time location information regarding the subscriber;
storing accumulated location information as a location history for the subscriber;
determining behavioral patterns exhibited by the subscriber based on location history; and
creating a behavioral profile associated with the subscriber based on the behavioral patterns exhibited by the subscriber.

9. The method of claim 8, further comprising:
receiving historical behavior information;
wherein determining behavioral patterns exhibited by the subscriber is further based on the historical behavior information.

10. The method of claim 8, wherein the location information includes information regarding associations between the mobile communication device and one or more network access points.

11. The method of claim 8, wherein the behavioral patterns include arrival or departure from a location.

12. The method of claim 8, wherein the behavioral patterns include purchase of a good or service.

13. The method of claim 8, wherein the behavioral patterns include transitioning from a first place of interest to a second place of interest.

14. An advertisement server comprising:
a processor and a database;
the processor configured to perform the steps of:
receiving real-time location information regarding an electronic device;
accessing a behavioral profile of a subscriber associated with the electronic device;
comparing the real-time location information with the behavioral profile to predict real-time behavior information;
selecting data based on the predicted real-time behavior information; and
transmitting the data to the electronic device of the subscriber for rendering.
